(19) United States
(12) Patent Application Publication
(10) Pub. No.: US 2025/0215173 A1
(43) Pub. Date: Jul. 3, 2025

(54) RESIN COMPOSITION AND METHOD FOR PREPARING THE SAME, AND PREPREG

(71) Applicant: NAN YA PLASTICS CORPORATION, TAIPEI (TW)

(72) Inventors: TE-CHAO LIAO, TAIPEI (TW); Ren-Yu Liao, New Taipei City (TW); HUNG-YI CHANG, TAIPEI (TW); CHIA-LIN LIU, TAIPEI (TW)

(21) Appl. No.: 18/626,471

(22) Filed: Apr. 4, 2024

(30) Foreign Application Priority Data
Dec. 27, 2023 (TW) 112150955

(51) Int. Cl. C08J 5/24; C08J 3/00; C08K 3/36

(52) U.S. Cl. CPC C08J 5/249; C08J 3/005; C08K 3/36; C08J 2383/06; C08K 2201/003

(57) ABSTRACT

A resin composition and a method for manufacturing the same, and a prepreg are provided. The method includes: implementing a ball mill process upon a filler to form a rough layer onto a surface of the filler, and then forming a chemically modified layer by attaching a polysiloxane onto the rough layer, so as to obtain a modified filler; and adding the modified filler into a heat resistant resin to form the resin composition. The polysiloxane has a functional group. An equivalent weight of the polysiloxane ranges from 1,500 g/mol to 10,000 g/mol.

### CROSS-REFERENCE TO RELATED PATENT APPLICATION

This application claims the benefit of priority to Taiwan Patent Application No. 112150955, filed on Dec. 27, 2023. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a resin composition and a method for manufacturing the same, and a prepreg, and more particularly to a resin composition and a method for manufacturing the same, and a prepreg that has a low thermal expansion coefficient.

### BACKGROUND OF THE DISCLOSURE

In order to improve efficiency, heterogeneous integration is one of the main development directions of the semiconductor industry. The core technology of the heterogeneous integration is advanced packaging.

The advanced packaging refers to a packaging technology for a wafer manufactured through a 7 nanometer lithography process. In response to the miniaturized structure, the advanced packaging technology requires extremely high dimensional accuracy and reliability. Therefore, a carrier substrate needs to have good dimensional stability and heat resistance.

In conventional materials of the carrier substrate, a large amount of fillers are added into the material so as to fulfill requirements for certain properties. However, the problem of filler settlement may occur due to the abundant fillers, which decreases the reliability and the production yield.

Therefore, how to solve the problem of filler settlement to achieve the expected reliability and meet the expected properties by improving the components of the carrier substrate has become an important issue to be addressed in the industry.

### SUMMARY OF THE DISCLOSURE

In response to the above-referenced technical inadequacy, the present disclosure provides a resin composition and a method for manufacturing the same, and a prepreg.

In order to solve the above-mentioned problems, one of the technical aspects adopted by the present disclosure is to provide a method for manufacturing a resin composition. The method includes: implementing a ball mill process upon a filler to form a rough layer onto a surface of the filler, and then forming a chemically modified layer by attaching a polysiloxane onto the rough layer, so as to obtain a modified filler; and adding the modified filler into a heat resistant resin to form the resin composition. The polysiloxane has a functional group. An equivalent weight of the polysiloxane ranges from 1,500 g/mol to 10,000 g/mol.

In one of the possible or preferred embodiments, during the ball mill process, a weight ratio of the filler to the polysiloxane ranges from 15 to 30.

In one of the possible or preferred embodiments, a diameter of the filler ranges from 0.1 μm to 2 μm.

In one of the possible or preferred embodiments, the polysiloxane and the filler undergo the ball mill process in a solvent, and the solvent is butanone, cyclohexanone, or toluene.

In one of the possible or preferred embodiments, the functional group is located on a side chain or a terminal end.

In one of the possible or preferred embodiments, the functional group includes an epoxy group or an amino group.

In one of the possible or preferred embodiments, a weight ratio of the modified fillers to the heat resistant resin ranges from 2.5 to 3.5.

In one of the possible or preferred embodiments, the heat resistant resin includes a bismaleimide resin, an epoxy resin, and a thermosetting acrylic resin.

In one of the possible or preferred embodiments, based on a total weight of the heat resistant resin being 100 wt %, the heat resistant resin includes 50 wt % to 70 wt % of the bismaleimide resin, 5 wt % to 15 wt % of the epoxy resin, and 10 wt % to 25 wt % of the thermosetting acrylic resin.

In order to solve the above-mentioned problems, another one of the technical aspects adopted by the present disclosure is to provide a resin composition. The resin composition includes a heat resistant resin and a modified filler dispersed in the heat resistant resin. A weight ratio of the modified filler to the heat resistant resin ranges from 2.5 to 3.5. A surface of the modified filler has a rough layer, and a chemically modified layer is formed on the rough layer. The chemically modified layer is formed from a polysiloxane. The polysiloxane has a functional group. An equivalent weight of the polysiloxane ranges from 1,500 g/mol to 10,000 g/mol.

In one of the possible or preferred embodiments, the functional group includes an epoxy group or an amino group.

In order to solve the above-mentioned problems, yet another one of the technical aspects adopted by the present disclosure is to provide a prepreg. The prepreg is formed by immersing a fiber substrate into the resin composition according to claim 10 and then being dried. The polysiloxane is cross-linked with the heat resistant resin via the functional group. The prepreg is used to form a resin substrate having a thermal expansion coefficient ranging from 1.0 ppm/° C. to 3.5 ppm/° C.

In one of the possible or preferred embodiments, a glass transition temperature of the resin substrate ranges from 340° C. to 360° C.

Therefore, in a resin composition and a method for manufacturing the same, and a prepreg provided by the present disclosure, by virtue of “implementing a ball mill process upon a filler” and “the polysiloxane having a functional group, and an equivalent weight of the polysiloxane ranging from 1,500 g/mol to 10,000 g/mol,” the resin substrate can have good thermal resistance and a low thermal expansion coefficient.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic view of a ball mill process in a method for manufacturing a resin composition according to the present disclosure;

FIG. 2 is a schematic view of a surface of a modified filler according to the present disclosure;

FIG. 3 is a schematic view of manufacturing a prepreg by using the resin composition according to the present disclosure; and

FIG. 4 is a schematic view of manufacturing a metal substrate by using the prepreg according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

The present disclosure provides a method for manufacturing a resin composition. A rough layer and a chemically modified layer can be formed on a surface of a filler by a ball mill process. The rough layer can increase a surface area of the filler, which is beneficial to the formation of the chemically modified layer. The chemically modified layer can enhance a dispersibility of the filler in the resin composition and prolong a settlement time of the filler in the resin composition. In this way, the resin composition can have good processability and the resin substrate can have good reliability.

The method for manufacturing a resin composition of the present disclosure includes: implementing the ball mill process upon the filler to obtain a modified filler (step S1); and adding the modified filler into a heat resistant resin to form the resin composition (step S2).

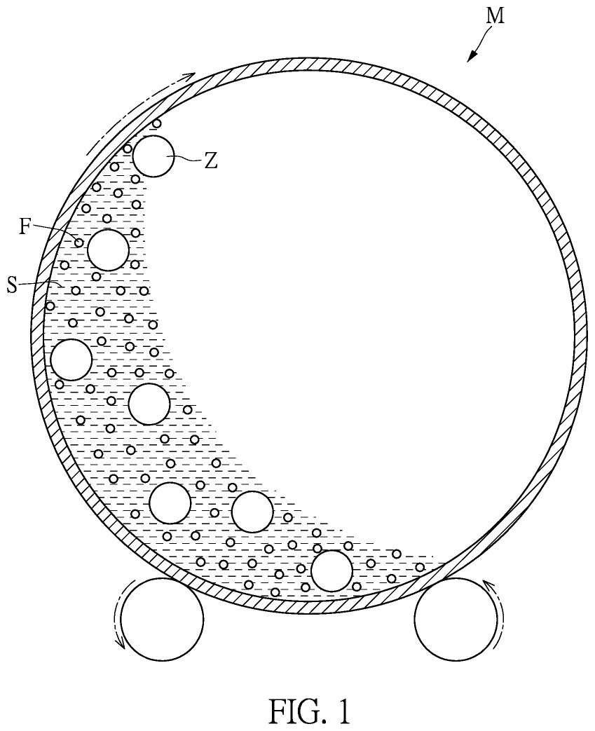

Referring to FIG. 1, FIG. 1 is a schematic view of the ball mill process. In the ball mill process, a filler F, a chemical modified solution, and a grinding ball Z are added into a ball mill M. In other words, the filler undergoes a wet ball mill process.

When the ball mill M is in operation, the filler F, the chemical modified solution, and the grinding ball Z are rolled in the ball mill M. During the ball mill process, the filler F is impacted and weltered by the grinding ball Z, thereby achieving a milling effect. Moreover, the rolling of the grinding ball Z helps disperse the aggregated filler F so as to restore the original surface area of the filler F that should have.

Specifically, a particle size of the filler F can range from 0.1 μm to 2 μm, such as 0.2 μm, 0.4 μm, 0.6 μm, 0.8 μm, 1.0 μm, 1.2 μm, 1.4 μm, 1.6 μm, or 1.8 μm, but the present disclosure is not limited thereto.

In an exemplary embodiment, the filler F can be silicon dioxide or boron nitride, but the present disclosure is not limited thereto. Specifically, the ball mill process can be implemented upon the filler F under a room temperature environment, and a rotation speed of the ball mill M can be set from 60 rpm to 720 rpm. The grinding ball Z can be zirconium dioxide. A particle size of the grinding ball Z can range from 0.5 mm to 5 mm.

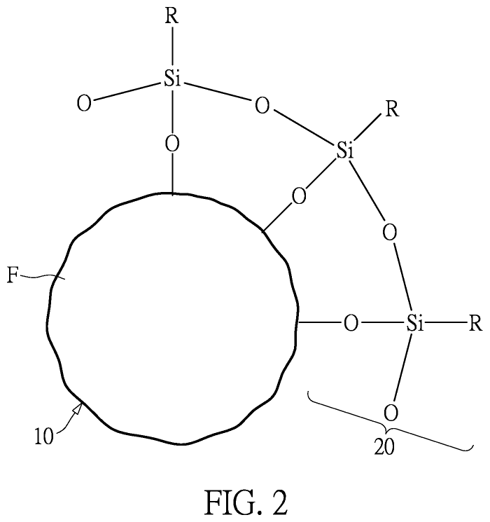

Referring to FIG. 2, after grinding the filler F, the rough layer 10 is formed onto the surface of the filler F. The rough layer 10 increases the surface area of the filler F and is beneficial to the formation of the chemically modified layer 20.

The chemically modified layer 20 is formed from a polysiloxane, and the polysiloxane is attached on the surface of the filler F and form a mesh structure. The polysiloxane has a functional group on a side chain or at a terminal end of its molecule. When the polysiloxane is attached on the filler F, the functional group is exposed from the surface of the filler F. The functional group can help disperse the filler F and enhance the thermal resistance of the resin composition.

Specifically, the polysiloxane is attached on the rough layer 10 via oxygen atoms, and the molecule chain (symbol “R” in FIG. 2) of the polysiloxane is located on the surface of the filler F to form the chemically modified layer 20.

After being ground, the filler F has a larger surface area (the rough layer 10) such that more polysiloxane can be attached onto the surface of the filler F. In order to form the chemically modified layer 20 with a stable structure, a weight ratio of the filler F to the polysiloxane can range from 15 to 30. Therefore, the chemically modified layer 20 with a stable structure can be formed by the least usage of the polysiloxane.

For example, the weight ratio of the filler F to the polysiloxane can be 17, 19, 21, 23, 25, 27, or 29.

The functional group of the polysiloxane can be an epoxy group or an amino group. The functional group can be located on the side chain or the terminal end of its molecule. An equivalent weight of the polysiloxane can range from 1,500 g/mol to 10,000 g/mol. Specific influences of the equivalent weight of the polysiloxane on the filler are described later.

Specifically, the equivalent weight of the polysiloxane can be 2,000 g/mol, 3,000 g/mol, 4,000 g/mol, 5,000 g/mol, 6,000 g/mol, 7,000 g/mol, 8,000 g/mol, or 9,000 g/mol, but the present disclosure is not limited thereto.

For a convenience of implementing the ball mill process, besides the polysiloxane, a solvent can be additionally added to promote the attachment between the filler F and the polysiloxane. In the present disclosure, the polysiloxane and the solvent are jointly referred to as the chemical modified solution S. The solvent in the chemical modified solution S can be butanone, cyclohexanone, or toluene, but the present disclosure is not limited thereto.

After forming the rough layer 10 on the surface of the filler F and forming the chemically modified layer 20 on the rough layer 10, the modified filler can be obtained. Subsequently, the modified filler can be added into the thermal resistance resin, so as to form the resin composition. In the resin composition, the thermal resistance resin acts as a continuous phase, and the modified filler is uniformly dispersed in the thermal resistance resin and acts as a dispersed phase.

It should be noted that, compared to the conventional resin composition, the resin composition of the present disclosure can contain a higher amount of the filler due to the modified filler processed through the ball mill process. Specifically, a weight ratio of the modified filler to the thermal resistance resin ranges from 2.5 to 3.5. For example, the weight ratio of the modified filler to the thermal resistance resin can be 2.75, 3.0, or 3.25.

In the present disclosure, components of the thermal resistance resin are not limited thereto. In an exemplary embodiment, the thermal resistance resin includes a bismaleimide resin, an epoxy resin, and a thermosetting acrylic resin. The bismaleimide resin, the epoxy resin, and the thermosetting acrylic resin have bondable functional groups. Therefore, the resin composition can have a good thermal resistance and a low thermal expansion coefficient after being cross-linked.

In addition, the chemically modified layer 20 of the modified filler has bondable functional groups. Therefore, compared to conventional filler, the usage of the modified filler can also enhance the thermal resistance and lower the thermal expansion coefficient of the resin composition after being cross-linked. Since the modified filler is uniformly dispersed in the thermal resistance resin, a resin substrate formed by cross-linking the resin composition can have the uniform thermal resistance and thermal expansion coefficient throughout the overall resin substrate.

In order to meet the expected properties of the resin substrate, the thermal resistance resin can contain a large amount of the bismaleimide resin. In an exemplary embodiment, an amount of the bismaleimide resin is higher than an amount of the epoxy resin and is higher than an amount of the thermosetting acrylic resin. Further, the amount of the bismaleimide resin can also be higher than a total amount of the epoxy resin and the thermosetting acrylic resin.

Specifically, based on a total weight of the thermal resistance resin being 100 wt %, the amount of the bismaleimide resin can range from 50 wt % to 70 wt %, the amount of the epoxy resin can range from 5 wt % to 15 wt %, and the amount of the thermosetting acrylic resin can range from 10 wt % to 25 wt %.

For example, the amount of the bismaleimide resin can be positive integers between 50 wt % and 70 wt %. The amount of the epoxy resin can be positive integers between 5 wt % to 15 wt %. The amount of the thermosetting acrylic resin can be positive integers between 10 wt % to 25 wt %.

The method for manufacturing a metal substrate of the present disclosure includes: immersing a fiber substrate into the resin composition and then drying the fiber substrate to obtain a prepreg (step S3); and disposing a metal layer onto the prepreg and heat-pressing the prepreg and the metal layer to obtain the metal substrate (step S4).

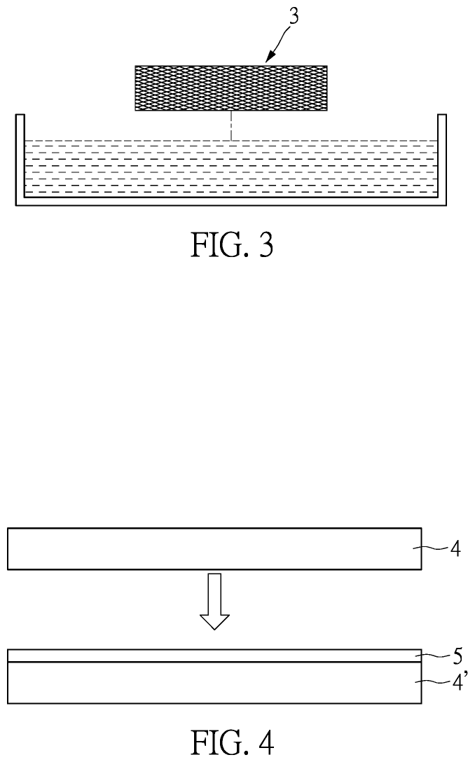

Referring to FIG. 3, FIG. 3 is a schematic view of manufacturing a prepreg by using the resin composition. In step S3, the resin composition is attached on a surface and intervals of the fiber substrate 3. After taking out and drying the fiber substrate 3, the prepreg 4 can be obtained (as shown in FIG. 4). At this time, the resin composition attached on the fiber substrate 3 has not yet been completely solidified; while, the prepreg 4 already has a fixed shape in appearance.

Referring to FIG. 4, FIG. 4 is a schematic view of manufacturing a metal substrate by using the prepreg. In step S4, the metal layer 5 is disposed on the prepreg 4. After implementing a heat-pressing process, the metal substrate can be obtained. At this time, the resin composition has been completely solidified, and the resin substrate is formed from the prepreg. The resin substrate has a high glass transition temperature (e.g., higher than 340° C.) and a low thermal expansion coefficient (e.g., lower than 3.5 ppm/° C.).

### Experimental Data

In order to prove the effect of the present disclosure, the metal substrates of Examples 1 to 5 and Comparative Examples 1 to 6 are manufactured according to the steps S1 to S4. Contents and properties of the resin composition are listed in Table 1 and Table 2.

### Example 1

75 g of silicon dioxide (filler) having a diameter ranging from 0.1 μm to 2 μm, 100 g of zirconium dioxide (grinding ball) having a diameter ranging from 0.5 mm to 5 mm, 3 g of polysiloxane, and 120 g of a mixture of methyl ethyl ketone, cyclohexanone, and toluene are added into a ball mill. The ball mill process is implemented for 0.5 hours to 5 hours at a rotation speed ranging from 60 rpm to 720 rpm, so as to obtain a modified filler. The polysiloxane has an epoxy group on the side chain of its molecule, and the equivalent weight of the polysiloxane is 10,000 g/mol.

After the modified filler is dried, 78 g of the modified filler is added into 22 g of the heat resistant resin to form the resin composition. The heat resistant resin includes: 50 wt % to 70 wt % of a bismaleimide resin, 5 wt % to 15 wt % of an epoxy resin, and 10 wt % to 25 wt % of a thermosetting acrylic resin.

In order to evaluate a dispersability of the modified filler in the heat resistant resin, an appropriate amount of the resin composition is filled in a sample bottle. In the sample bottle, the resin composition is filled by a height of 4 cm to 5 cm. Subsequently, a light transmittance and a reflection value of the sample bottle are measured by a dispersion stability and particle size analyzer (model: TURBISCAN), so as to calculate a stability index. When the stability index is higher than 3.0, it is regarded as settlement. In addition, a time period for the resin composition to reach the stability index of 3.0 is regarded as a settlement time for the resin composition.

A fiber substrate provided by Nan Ya Plastics Corporation (model: 2116) is immersed into the said resin composition, such that the resin composition is attached onto the fiber substrate. The fiber substrate is taken out and dried at a temperature ranging from 100° C. to 140° C., so as to obtain a prepreg. A metal layer is disposed on the prepreg, and is then heat-pressed at a temperature ranging from 200° C. to 270° C. and a pressure ranging from 10 kg/cm² to 30 kg/cm², so as to obtain a metal substrate. In the metal substrate, the prepreg has been completely solidified to form a resin substrate.

In order to measure properties of the resin substrate, the metal layer is removed from the resin substrate. E′ (storage modulus), E″ (loss modulus), and Tanδ (a ratio of E″ to E′, abbreviated as E″/E′) of the resin substrate are measured by a dynamic mechanical analyzer (DMA, brand: TA instrument). A temperature at which has the highest Tanδ (E″ /E′) is glass transition temperature (Tg). A difference between a low temperature based line and the glass transition temperature is calculated, and the difference is negatively proportional to a crosslinking degree. In the present disclosure, when the difference is lower than 0.02, it indicates a high crosslinking degree. When the difference ranges from 0.02 to 0.04, it indicates a moderate crosslinking degree. When the difference is higher than 0.04, it indicates a low crosslinking degree.

A thermal expansion coefficient ranging from 50° C. to 120° C. of the resin substrate after removing the metal layer is measured by a thermal mechanical analyzer (TMA, brand TA instrument).

In addition, a water absorption ratio of the resin substrate is calculated by weighing the resin substrate before and after being placed at an environment of a temperature of 120° C. and a relative humidity of 100% for 2 hours.

### Examples 2 to 5

The metal substrate of Examples 2 to 5 are manufactured by the similar method for manufacturing the metal substrate of Example 1. The properties of the metal substrate of Examples 2 to 5 are measured by the similar methods mentioned above. The difference is that the components and the contents of the polysiloxane for the ball mill process used in Examples 2 to 5 are different from that used in Example 1.

Specifically, the functional group of the polysiloxane in Example 2 is an epoxy group and is located on the side chain of its molecule, and an equivalent weight of the polysiloxane is 1,500 g/mol. The functional group of the polysiloxane in Example 3 is an epoxy group and is located on the side chain of its molecule, and an equivalent weight of the polysiloxane is 3,800 g/mol. The functional group of the polysiloxane in Example 4 is an amino group and is located on the side chain of its molecule, and an equivalent weight of the polysiloxane is 2,400 g/mol. The functional group of the polysiloxane in Example 5 is an epoxy group and is located on the terminal end of its molecule, and an equivalent weight of the polysiloxane is 2,400 g/mol.

### Comparative Examples 1 and 2

The metal substrates of Comparative Examples 1 and 2 are manufactured by the similar method for manufacturing the metal substrates of Examples 1 and 2. The properties of the metal substrate of Comparative Examples 1 and 2 are measured by the similar methods mentioned above. The difference is that the filler and the polysiloxane are directly mixed without implementing the ball mill process in Comparative Examples 1 and 2.

### Comparative Example 3

The metal substrate of Comparative Example 3 is manufactured by the similar method for manufacturing the metal substrate of Example 1. The properties of the metal substrate of Comparative Example 3 are measured by the similar methods mentioned above. The difference is that the polysiloxane is absent from the ball mill process in Comparative Example 3.

### Comparative Example 4

The metal substrate of Comparative Example 4 is manufactured by the similar method for manufacturing the metal substrate of Comparative Example 3. The properties of the metal substrate of Comparative Example 4 are measured by the similar methods mentioned above. The difference is that the ball mill process is not implemented, and the filler and the heat resistant resin are directly mixed to form the resin composition in Comparative Example 4.

### Comparative Examples 5 and 6

The metal substrates of Comparative Examples 5 and 6 are manufactured by the similar method for manufacturing the metal substrates of Example 1. The properties of the metal substrate of Comparative Examples 5 and 6 are measured by the similar methods mentioned above. The difference is that the components and the contents of the polysiloxane are used in the ball mill process in Comparative Examples 5 and 6. Specifically, the functional group of the polysiloxane in Comparative Example 5 is an epoxy group and is located on the side chain of its molecule, and an equivalent weight of the polysiloxane is 300 g/mol. The functional group of the polysiloxane in Comparative Example 6 is an epoxy group and is located on the side chain of its molecule, and an equivalent weight of the polysiloxane is 15,000 g/mol. In other words, the equivalent weight of the polysiloxane in Comparative Examples 5 and 6 does not range within a range from 1,500 g/mol to 10,000 g/mol.

TABLE 1

| | | Example | | Comparative Example | | | |
|---|---|---|---|---|---|---|---|
| (phr) | | 1 | 2 | 1 | 2 | 3 | 4 |
| Filler (silicon dioxide) | | 75 | 70 | 75 | 70 | 75 | 75 |
| poly- | Epoxy group | — | 4 | — | 4 | — | — |
| siloxane | on side chain, | | | | | | |
| | equivalent | | | | | | |
| | weight: | | | | | | |
| | 500 g/mol | | | | | | |
| | Epoxy group | 3 | — | 3 | — | — | — |
| | on side chain, | | | | | | |
| | equivalent | | | | | | |
| | weight: 10,000 | | | | | | |
| | g/mol | | | | | | |

| | | | | | | |
|---|---|---|---|---|---|---|
| Ball mill process | Yes | Yes | No | No | Yes | No |
| Heat resistant resin | 22 | 26 | 22 | 26 | 25 | 25 |
| Settlement time (hour) | 168 | 240 | 72 | 96 | 60 | 48 |
| Glass transition | 345 | 350 | 330 | 330 | 325 | 315 |
| temperature | | | | | | |
| (° C.) | | | | | | |
| Thermal expansion | 2.2 | 2.4 | 3.6 | 3.7 | 4.2 | 4.5 |
| coefficient | | | | | | |
| (ppm/° C.) | | | | | | |
| Water absorption | 0.3 | 0.3 | 0.4 | 0.4 | 0.5 | 0.5 |
| ratio (%) | | | | | | |
| Crosslinking degree | High | High | Mod- | Mod- | Low | Low |
| | | | erate | erate | | |

According to Examples 1 and 2 and Comparative Examples 1 to 4, the chemically modified layer can be formed onto the surface of the filler through the ball mill process. Therefore, the modified filler can be uniformly dispersed in the heat resistant resin and has a good stability. Even if the resin composition is rested, the modified filler will not settle down. In addition, after being completely solidified, the resin substrate can have a high glass transition temperature, a high crosslinking degree, a low thermal expansion coefficient, and a low water absorption ratio.

Specifically, the glass transition temperature of the resin substrate is higher than 340° C., and preferably ranges from 342° C. to 360° C. The thermal expansion coefficient of the resin substrate is lower than 3.5 ppm/° C., and preferably ranges from 1.5 ppm/° C. to 2.8 ppm/° C.

TABLE 2

| | | | | | Comparative | |
|---|---|---|---|---|---|---|
| | | Example | | | Example | |
| (phr) | | 3 | 4 | 5 | 5 | 6 |
| Filler (silicon dioxide) | | 75 | 75 | 75 | 75 | 75 |
| poly- | Epoxy group | — | — | — | 3 | — |
| siloxane | on side chain, | | | | | |
| | equivalent | | | | | |
| | weight: 300 | | | | | |
| | g/mol | | | | | |
| | Epoxy group | — | — | — | — | 3 |
| | on side chain, | | | | | |
| | equivalent | | | | | |
| | weight: 15,000 | | | | | |
| | g/mol | | | | | |
| | Epoxy group | 3 | — | — | — | — |
| | on side chain, | | | | | |
| | equivalent | | | | | |
| | weight: 3,800 | | | | | |
| | g/mol | | | | | |
| | Amino group | — | 3 | — | — | — |
| | on side chain, | | | | | |
| | equivalent | | | | | |
| | weight: 2,400 | | | | | |
| | g/mol | | | | | |
| | Epoxy group | — | — | 3 | — | — |
| | at terminal | | | | | |
| | end, equivalent | | | | | |
| | weight: | | | | | |
| | 2,400 g/mol | | | | | |

| | | | | | |
|---|---|---|---|---|---|
| Ball mill process | Yes | Yes | Yes | Yes | Yes |
| Heat resistant resin | 22 | 22 | 22 | 22 | 22 |
| Settlement time (hour) | 240 | 216 | 216 | 96 | 216 |
| Glass transition | 345 | 345 | 345 | 350 | 310 |
| temperature (° C.) | | | | | |
| Thermal expansion | 2.4 | 2.4 | 2.3 | 3.2 | 2.9 |
| coefficient (ppm/° C.) | | | | | |
| Water absorption ratio (%) | 0.3 | 0.3 | 0.3 | 0.4 | 0.4 |
| Crosslinking degree | High | High | High | High | Moderate |

According to Examples 3 to 5 and Comparative Examples 5 and 6, the equivalent weight of the polysiloxane will influence the properties of the modified filler. When the equivalent weight of the polysiloxane is high, there are few functional group shown on the surface of the polysiloxane, such that the thermal resistance of the resin substrate cannot be effectively enhanced. Hence, the glass transition temperature of the resin substrate is low (Comparative Example 6). When the equivalent weight of the polysiloxane is low, the thermal resistance of the resin substrate can be increased; while the dispersibility of the filler is poor, which causes a high thermal expansion coefficient (Comparative Example 5).

Accordingly, a preferable equivalent weight of the polysiloxane ranges from 1,500 g/mol to 10,000 g/mol.

According to Examples 4 and 5, the functional group of the polysiloxane can be located on not only the side chain but also the terminal end of its molecule. Moreover, the functional group can be the epoxy group or the amino group, which can achieve the effect of the present disclosure.

### Beneficial Effects of the Embodiments

In conclusion, in a resin composition and a method for manufacturing the same, and a prepreg provided by the present disclosure, by virtue of “implementing a ball mill process upon a filler” and “the polysiloxane having a functional group, and an equivalent weight of the polysiloxane ranging from 1,500 g/mol to 10,000 g/mol,” the resin substrate can have good thermal resistance and a low thermal expansion coefficient.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for manufacturing a resin composition, comprising:
implementing a ball mill process upon a filler to form a rough layer onto a surface of the filler, and then forming a chemically modified layer by attaching a polysiloxane onto the rough layer, so as to obtain a modified filler; wherein the polysiloxane has a functional group, and an equivalent weight of the polysiloxane ranges from 1,500 g/mol to 10,000 g/mol; and
adding the modified filler into a heat resistant resin to form the resin composition.

2. The method according to claim 1, wherein, during the ball mill process, a weight ratio of the filler to the polysiloxane ranges from 15 to 30.

3. The method according to claim 1, wherein a diameter of the filler ranges from 0.1 μm to 2 μm.

4. The method according to claim 1, wherein the polysiloxane and the filler undergo the ball mill process in a solvent, and the solvent is butanone, cyclohexanone, or toluene.

5. The method according to claim 1, wherein the functional group is located on a side chain or a terminal end.

6. The method according to claim 1, wherein the functional group includes an epoxy group or an amino group.

7. The method according to claim 1, wherein a weight ratio of the modified fillers to the heat resistant resin ranges from 2.5 to 3.5.

8. The method according to claim 1, wherein the heat resistant resin includes a bismaleimide resin, an epoxy resin, and a thermosetting acrylic resin.

9. The method according to claim 8, wherein, based on a total weight of the heat resistant resin being 100 wt %, the heat resistant resin includes 50 wt % to 70 wt % of the bismaleimide resin, 5 wt % to 15 wt % of the epoxy resin, and 10 wt % to 25 wt % of the thermosetting acrylic resin.

10. A resin composition, comprising:
a heat resistant resin; and
a modified filler dispersed in the heat resistant resin; wherein a weight ratio of the modified filler to the heat resistant resin ranges from 2.5 to 3.5; wherein a surface of the modified filler has a rough layer and a chemically modified layer formed on the rough layer; wherein the chemically modified layer is formed from a polysiloxane, the polysiloxane has a functional group, and an equivalent weight of the polysiloxane ranges from 1,500 g/mol to 10,000 g/mol.

11. The resin composition according to claim 10, wherein the functional group includes an epoxy group or an amino group.

12. A prepreg formed by immersing a fiber substrate into the resin composition according to claim 10 and then drying the fiber substrate, wherein the polysiloxane is crosslinked with the heat resistant resin via the functional group, wherein the prepreg is used to form a resin substrate having a thermal expansion coefficient ranging from 1.0 ppm/° C. to 3.5 ppm/° C.

13. The prepreg according to claim 12, wherein a glass transition temperature of the resin substrate ranges from 340° C. to 360° C.
